(19) United States
(12) Patent Application Publication
(10) Pub. No.: US 2004/0035616 A1
(43) Pub. Date: Feb. 26, 2004

(54) Scooter

(76) Inventor: Fang-Chun Yu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/224,510

(22) Filed: Aug. 21, 2002

(51) Int. Cl. B60K 1/00

(52) U.S. Cl. 180/65.1; 180/181

(57) ABSTRACT

A scooter is constructed to include a front fork holding a front wheel, a base frame holding a pair of rear wheels, a coupling plate extended from the base frame and coupled to the front fork, and a toe-controlled steering control frame coupled to the coupling plate of the base frame and fastened to the front fork for controlling the steering direction of the front wheel with the toes.

### BACKGROUND OF THE INVENTION

1. Field of the Invention

The present invention relates to scooters and, more particularly, to such a scooter, which enables the rider to control the steering direction with the toes.

2. Description of the Related Art

A variety of kick scooters and motor-driven scooters have been disclosed, and have appeared on the market. These scooters commonly comprise a flat base frame, a front fork holding a front wheel, a coupling device coupled between the front fork and the flat base frame, a pair of rear wheels bilaterally pivoted to the flat base frame, and a handlebar fixedly fastened to the top end of the front fork for steering control. According to these conventional designs, the user must manipulate the handlebar to control the steering direction. Riding these scooters require skill.

### SUMMARY OF THE INVENTION

The present invention has been accomplished under the circumstances in view. It is one object of the present invention to provide a scooter, which enables the rider to control the steering direction conveniently with the toes. It is still another object of the present invention to provide a scooter, which is safe and comfortable in riding. To achieve these and other objects of the present invention, the scooter comprises a front fork holding a front wheel, a base frame holding a pair of rear wheels, a coupling plate extended from the base frame and coupled to the front fork, and a toe-controlled steering control frame coupled to the coupling plate of the base frame and fastened to the front fork for controlling the steering direction of the front wheel with the toes. When riding the scooter, the rider has one foot fixedly fastened to the heel strap and toe binding, and the other foot worn with a roller-skate.

### BRIEF DESCRIPTION OF THE DRAWINGS

FIG. 1 is a perspective view of a scooter according to the present invention.

FIG. 2 is an exploded view of the scoter according to the present invention.

FIG. 3 is a sectional view of the steering control frame according to the present invention.

FIG. 4 is a side view showing the rider's foot fastened to the heel strap and the toe binding according to the present invention.

FIG. 5 is a schematic drawing showing the rider's one foot fastened to the scooter and the other foot of the rider worn with a roller-skate.

FIGS. 6A˜6C are schematic drawings showing steering control actions of the present invention.

### DETAILED DESCRIPTION OF THE PREFERRED EMBODIMENT

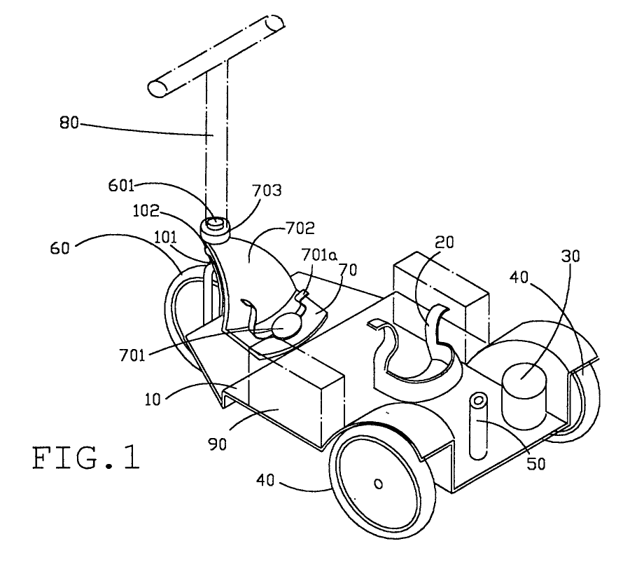

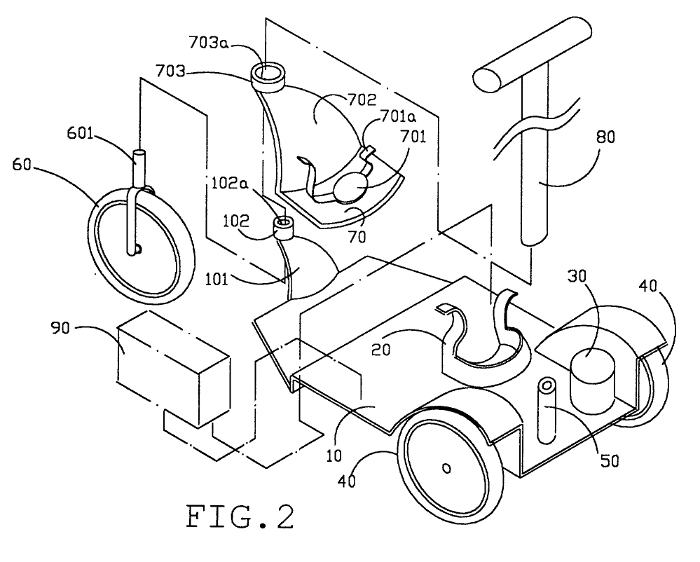

Referring to FIGS. 1 and 2, a scooter is shown comprising a flat base frame 10, a front fork 601, a front wheel 60 pivoted to the front fork 601, and a steering control frame 70.

The flat base frame 10 comprises an arched front coupling plate 101, a barrel 102 vertically formed integral with one end, namely, the front end of the locating plate 101 and defining an axle hole 102a, a transmission mechanism 30 and an upright rod 50 disposed near the rear side thereof, a heel strap 20 provided at the top near the rear side in front of the transmission mechanism 30 and the upright rod 50, a battery box 90 disposed at one side, and two rear wheels 40 bilaterally disposed near the rear side.

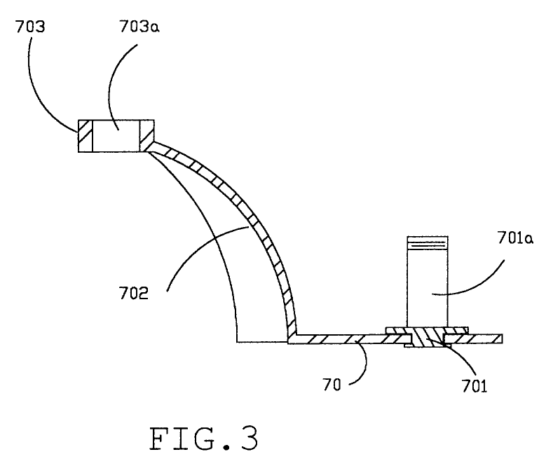

Referring to FIG. 3 and FIGS. 1 and 2 again, the steering control frame 70 comprises a disk 701 pivoted thereto, a toe binding 701a provided at the disk 701, an arched front plate 702 fitting over the locating plate 101 of the base frame 10, and a coupling ring 703 formed integral with the front side of the arched front plate 792. The inner diameter 703a of the coupling ring 703 fits the outer diameter of the front fork 601. The barrel 102 of the arched front coupling plate 101 of the flat base frame 10 is coupled to the top end of the front fork 601. The coupling ring 703 of the arched front plate 702 is supported on the barrel 102 of the arched front coupling plate 101 and fixedly fastened to the top end of the front fork 601. Further, the transmission mechanism 30 is electrically connected to the battery box 90 and controlled (by a wired control device or remote controller) to rotate the rear wheels 40.

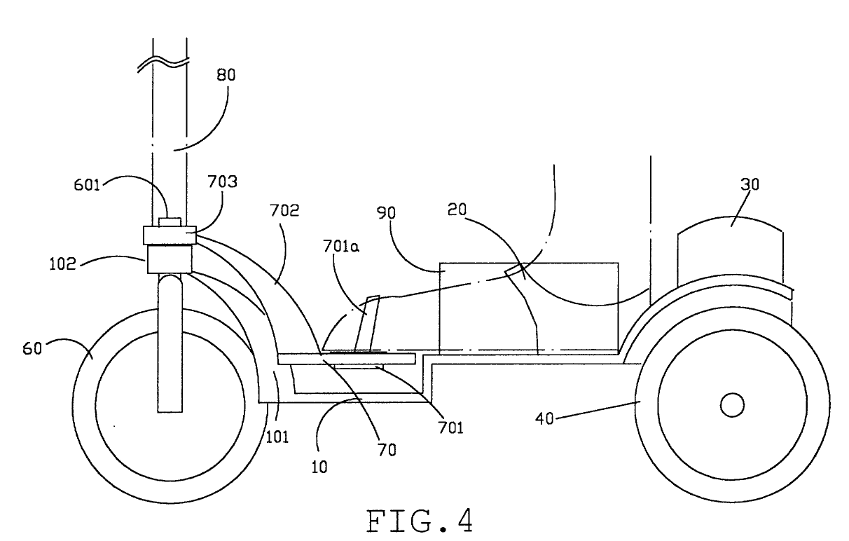

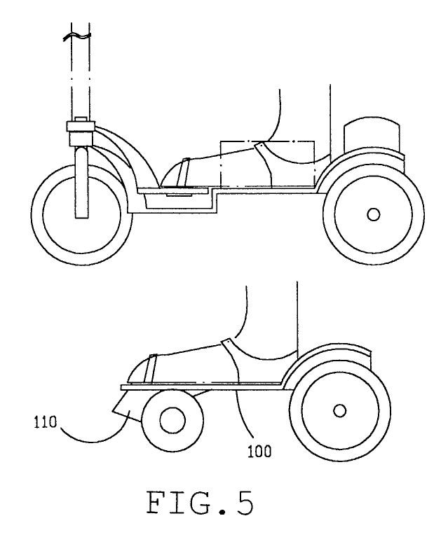

Referring to FIGS. 4 and 5, when in use, one foot is fastened to the heel strap 20 and the toe binding 701a, and the other the other foot is worn with a roller-skate 100. Thus, the user can ride the scooter and control the transmission mechanism 30 to move the scooter.

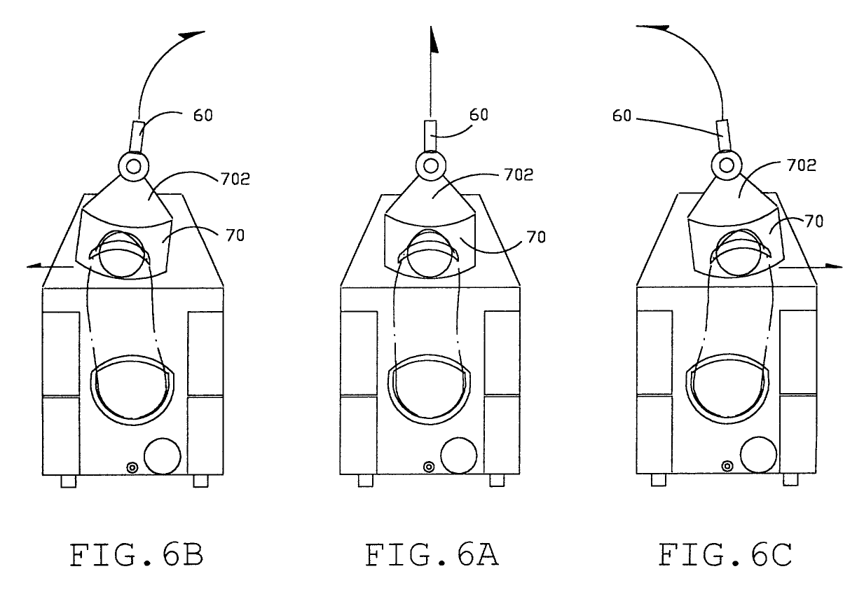

Referring to FIGS. 6A˜6C, the user can force the toes to rotate the disk 701, so as to further drive the steering control frame 70 to turn the front wheel 60 to the desired direction.

Referring to FIGS. 1, 2 and 4 again, a handle 80 can be inserted into the coupling ring 703 and fixedly fastened to the top end of the front fork 601 for enabling the rider to control the steering direction of the front wheel 60 with the hands.

Referring to FIG. 4 and FIG. 5 again, by means of controlling the controlling the controller to drive the brake (not shown) and to stop the toe stop 110 against the round surface, the scooter is stopped.

Referring to FIG. 1 again, the upright rod 50 is provided for hanging a basket, travel bag, chair, or any of a variety of the user's personal items.

A prototype of scooter has been constructed with the features of FIG. 16. The scooter functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A scooter comprising:
a flat base frame, said base frame comprising an arched front coupling plate, a barrel vertically formed integral with a front end of said locating plate, an upright rod disposed near a rear side thereof, a heel strap provided at a top side thereof in front of said upright rod, and two rear wheels bilaterally pivoted thereto near the rear side;
a battery box installed in said flat base frame;
a transmission mechanism installed in said flat base frame and controlled to rotate said rear wheels;
a front fork holding a front wheel; and
a steering control frame coupled between said front fork and the arched front coupling plate of said flat base frame and adapted for controlling steering direction of said front wheel, said steering control frame comprising a disk, a toe binding provided at said disk, an arched front plate fitting over the locating plate of said base frame, and a coupling ring formed integral with a front side of said arched front plate and supported on the barrel of the arched front coupling plate of said flat base frame and fixedly fastened to a top end of said front fork.
